(19) United States
(12) Patent Application Publication
(10) Pub. No.: US 2023/0309003 A1
(43) Pub. Date: Sep. 28, 2023

(54) METHODS, NODES AND COMPUTER READABLE MEDIA FOR SGW-U SELECTION

(71) Applicant: Telefonaktiebolaget LM Ericsson (publ), Stockholm (SE)

(72) Inventors: Dongxia ZHU, Shanghai (CN); Zhiwei QU, Shanghai (CN); Zhiqiang ZHAO, Shanghai (CN)

(21) Appl. No.: 18/017,489

(22) PCT Filed: Aug. 20, 2020
(86) PCT No.: PCT/CN2020/110227

§ 371 Date: Jan. 23, 2023

(51) Int. Cl. H04W 48/18

(52) U.S. Cl. CPC H04W 48/18; H04W 88/16

(57) ABSTRACT

The present disclosure provides methods, nodes, and computer readable media for selection of an SGW-U node. The present disclosure further describes a method at a mobility management node that includes receiving, from a network node, identification information of an SGW-U node; and storing the received identification information of the SGW-U node.

### TECHNICAL FIELD

The present disclosure generally relates to the technical field of communication technologies, and particularly to methods, nodes and computer readable media for Serving Gateway-User plane (SGW-U) selection.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In the Control and User Plane Separation (CUPS) architecture of Evolved Packet Core (EPC) nodes, SGW-C and SGW-U are separated.

To reduce latency and considering Multiple-Access Edge Computing (MEC), SGW-U is needed to be closer to the Radio Access Network (RAN) or more appropriate for the intended UE usage type without increasing the number of Serving Gateway-Control plane (SGW-C) nodes. To support increase of data traffic, more SGW-U nodes are added without changing the number of SGW-C nodes.

Mobility Management Entity (MME) / S4-Serving GPRS Support Node (S4-SGSN) is responsible for selection of SGW-C, and SGW-C is responsible for selection of SGW-U. MME/S4-SGSN is not aware of the information of SGW-U.

For SGW-U selection, the SGW-C needs to consider SGW-U location information (e.g. SGW Service Area), and UE location information provided by the MME/S4-SGSN, in order to select a user plane (UP) function close to the UE’s point of attachment. In order to allow the SGW-C to select an SGW-U, the MME/S4-SGSN may provide e.g., location information of the UE (such as Evolved-Universal Mobile Telecommunications System (UMTS) Terrestrial Radio Access Network (E-UTRAN) Cell Global Identifier (ECGI), eNB or Tracking Area Identity (TAI) for E-UTRAN, or Routing Area Identity (RAI) or Radio Network Controller (RNC-ID) for UMTS Terrestrial Radio Access Network (UTRAN)), Access Point Name (APN) used by the UE (for selection of a combined SGW/Packet data network Gateway (PGW)), relevant UE capabilities when available (e.g. UE support for dual connectivity with New Radio (NR)), and may provide the mapped UE Usage Type in the Create Session Request message over the S11/S4 interface.

In the CUPS architecture, when the UE moves from one SGW-U service area to another SGW-U service area but within the same SGW-C service area, such a problem may arise that since the MME/S4-SGSN finds that the SGW (SGW-C) can still serve the UE, the MME/S4-SGSN considers that the SGW doesn’t change and the SGW-C may lose a chance to reselect an SGW-U; thus, the user plane may be kept there, and this might result in that the SGW-U is a bit far from the RAN side.

With the CUPS deployment, many customers have encountered such a problem in live network. For example, in the China Mobile Communications Group (CMCC) network, an SGW-C pool service area covers a whole province, and an SGW-U pool service area only covers one or some cities in a province. When the UE moves between different SGW-U pool service areas but within the same SGW-C pool service area, the above problem occurs. The customers would like the vendors to support user plane reselection in order to accelerate the MEC in the network.

To solve this problem, the 3GPP proposes a solution “SGW-C Partitioning” which has been standardized in 3GPP TS 23.214 V16.0.0. The solution is that if the SGW-U service area is smaller than the SGW-C service area, the SGW-C can be partitioned into multiple SGW-C partitions. Each of the SGW-C partition is aligned with the corresponding SGW-U service area. The MME/S4-SGSN treats the SGW-C partition as legacy SGW.

However, this “SGW-C Partitioning” solution introduces new problems:

1. When the UE moves from one SGW-U service area to another SGW-U service area but within the same SGW-C service area to trigger a mobility procedure, the SGW changes from the MME’s point of view, and the MME will send a Create Session Request message to the SGW-C, and later send a Delete Session Request message to the same SGW-C as a part of mobility procedure with SGW relocation. It may introduce some session handling problems in the SGW-C, and it’s not signaling saving either.

2. If the SGW-C service areas overlap with each other (e.g. a SGW-C pool), when the UE moves within the overlapped areas with SGW-U change, the MME might select an SGW-C partition of another physical SGW-C during SGW reselection, even the current physical SGW-C can serve the UE. Then, S11 connection might be changed to another physical SGW-C, which would lower the benefit with the SGW-C partitioning.

3. In some operators’ network, all SGW-Cs serving a bigger location area (e.g., a province) are in a pool, and the SGW-Us serving a smaller location area (e.g., a city) are in a pool. The “SGW-C Partitioning” needs the operators to split one SGW-C pool to several SGW-C partition sub-pools, which is additional work for the operators.

4. With support of the SGW-C partitioning, the whole network should be forced to deploy this feature for all services. Even if some UEs or APNs are not applicable for MEC service, i.e. the UE doesn’t need to be closer to the SGW-U, “SGW-C Partitioning” might introduce unnecessary SGW change for the UE when the UE moves from the service area of one SGW-C partition to the service area of another SGW-C partition. It also leads to unnecessary TAI list update between the UE and the MME when the UE moves across the boundary of the SGW-C partitions.

Therefore, a technical solution that may solve the above problem without those disadvantages of the “SGW-C Partitioning” solution is desired.

### SUMMARY

In order to solve or at least alleviate the problem as discussed above and meanwhile to promote the CUPS architecture to enjoy the benefits it brings, the present disclosure provides technical solutions for SGW-U selection/reselection, in which the MME/S4-SGSN becomes aware of part of SGW-U information and assists the SGW-C to select/reselect the SGW-U, so as to ensure that the UE can always be served by the suitable SGW-C and SGW-U after mobility.

According to a first aspect of the present disclosure, a method at a mobility management node is provided. The method includes: receiving, from a network node, identification information of an SGW-U node; and storing the received identification information of the SGW-U node.

In an exemplary embodiment, the identification information of the SGW-U node includes at least one of:
node name information of the SGW-U node, or
node IP information of the SGW-U node.

In an exemplary embodiment, the network node is an SGW-C node, the SGW-U node was selected by the SGW-C node, and the identification information of the SGW-U node from the SGW-U node is carried by one of:
a Create Session Response message, or
a Modify Bearer Response message.

In an exemplary embodiment, the network node is another mobility management node, the SGW-U node was selected by an SGW-C node, and the identification information of the SGW-U node from the other mobility management node is carried by one of:
a Context Response message, or
a Forward Relocation Request message.

In an exemplary embodiment, any of the mobility management node and the other mobility management node includes at least one of: an MME, or an S4-SGSN.

In an exemplary embodiment, the method further includes: selecting an SGW-C node at least partially based on location information of a UE.

In an exemplary embodiment, the method further includes:
obtaining a list of identification information of SGW-U nodes at least partially based on location information of the UE;
determining that the SGW-U node needs change if the stored identification information of the SGW-U node is not in the obtained list; and
transmitting an indication of reselecting an SGW-U node to the selected SGW-C node.

In an exemplary embodiment, the indication of reselecting an SGW-U node is carried by a Modify Bearer Request message, and includes at least the location information of the UE; and the identification information of the SGW-U node from the selected SGW-C node is carried by the Modify Bearer Response message.

In an exemplary embodiment, the method further includes: allocating, to the UE, a Tracking Area Identity ‘TAI’ list containing one or more TAs which can all be served by both the currently selected SGW-C node and SGW-U node.

According to a second aspect of the present disclosure, a method at an SGW-C node is provided. The method includes: selecting an SGW-U node for serving a UE; and transmitting, to a mobility management node, identification information of the SGW-U node.

In an exemplary embodiment, the identification information of the SGW-U node includes at least one of:
node name information of the SGW-U node, or
node IP information of the SGW-U node.

In an exemplary embodiment, the identification information of the SGW-U node is carried by one of:
a Create Session Response message, or
a Modify Bearer Response message.

In an exemplary embodiment, the SGW-C node was selected by the mobility management node at least partially based on location information of the UE.

In an exemplary embodiment, the method further includes: receiving, from the mobility management node, an indication of reselecting an SGW-U node; and reselecting an SGW-U node.

In an exemplary embodiment, the indication of reselecting an SGW-U node is carried by a Modify Bearer Request message, and includes at least location information of the UE, or an indication flag indicating that the SGW-U node needs change; and the identification information of the SGW-U node is carried by the Modify Bearer Response message.

In an exemplary embodiment, the mobility management node includes at least one of: an MME, or an S4-SGSN.

According to a third aspect of the present disclosure, a mobility management node is provided. The mobility management node includes: at least one processor, and at least one memory, storing instructions which, when executed on the at least one processor, cause the mobility management node to perform the method according to the first aspect of the present disclosure.

According to a fourth aspect of the present disclosure, an SGW-C node is provided. The SGW-C node includes: at least one processor, and at least one memory, storing instructions which, when executed on the at least one processor, cause the SGW-C node to perform the method according to the second aspect of the present disclosure.

According to a fifth aspect of the present disclosure, a computer readable storage medium is provided. The computer readable storage medium has computer program instructions stored thereon, the computer program instructions, when executed by at least one processor, causing the at least one processor to perform the method according to any of the first and second aspects of the present disclosure.

The technical solutions of the present disclosure may achieve at least benefits of:
securing that the UE can always be served by the SGW-U close to the UE in mobility;
no need of SGW-C partitioning, which saves signaling;
avoiding unnecessary SGW-C change when the SGW-C service areas overlap with each other;
avoiding splitting one SGW-C pool to multiple SGW-C sub-pools;
providing more flexible SGW-C/SGW-U selection based on PDN level to avoid unnecessary SGW change when the UE/APN is not applicable for MEC service, i.e. not necessary to be closer to SGW-U.

### BRIEF DESCRIPTION OF THE DRAWINGS

The objects, advantages and characteristics of the present disclosure will be more apparent, according to descriptions of preferred embodiments in connection with the drawings, in which:

FIG. 1 schematically shows a method at a mobility management node for SGW-U selection according to an exemplary embodiment of the present disclosure;

FIG. 2 schematically shows a method at an SGW-C node for SGW-U selection according to an exemplary embodiment of the present disclosure;

FIG. 3 schematically shows an exemplary signaling sequence diagram of a PDN Connectivity procedure or a Mobility procedure with SGW-C Change in which methods for SGW-U selection according to exemplary embodiments of the present disclosure are applied;

FIG. 4 schematically shows an exemplary signaling sequence diagram of a Mobility procedure without SGW-C change but with SGW-U change in which methods for SGW-U selection according to exemplary embodiments of the present disclosure are applied;

FIG. 5 schematically shows an exemplary signaling sequence diagram in an inter-MME Tracking Area Update procedure in which methods for SGW-U selection according to exemplary embodiments of the present disclosure are applied;

FIG. 6 schematically shows an exemplary signaling sequence diagram in an inter-MME Handover procedure in which methods for SGW-U selection according to exemplary embodiments of the present disclosure are applied;

FIG. 7 schematically shows an exemplary scenario in which SGW-U selection according to an exemplary embodiment of the present disclosure is applied during intra-MME Mobility without SGW-C change;

FIG. 8 schematically shows a structural block diagram of a mobility management node according to an exemplary embodiment of the present disclosure;

FIG. 9 schematically shows a structural block diagram of a mobility management node according to another exemplary embodiment of the present disclosure;

FIG. 10 schematically shows a structural block diagram of an SGW-C node according to an exemplary embodiment of the present disclosure; and

FIG. 11 schematically shows a structural block diagram of an SGW-C node according to another exemplary embodiment of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “and/or” includes any and all combinations of one or more of the associated listed terms.

In the following description and claims, unless defined otherwise, all technical and scientific terms used herein have the same meaning as commonly understood by one of ordinary skills in the art to which this disclosure belongs.

It should be appreciated that the term “node” used herein may also be a virtualized node that may be implemented on cloud.

The basic ideas of the present disclosure mainly consist in that
During mobility procedures, when the serving MME/S4-SGSN finds that the SGW-C node (also called “SGW-C” throughout the specification) doesn’t need to be relocated, the MME/S4-SGSN uses a Domain Name System (DNS) procedure, such as a Straightforward-Name Authority Pointer (S-NAPTR) procedure, to obtain a list of identification information of SGW-U nodes (e.g., a list of SGW-U node names, such as Fully Qualified Domain Names (FQDNs), and/or a list of SGW-U node IPs) at least partially based on location information of the UE, and optionally on UE Usage Type, the APN, UE capabilities etc. The MME/S4-SGSN determines whether the current SGW-U node is in the list. If the current SGW-U node (also called “SGW-U” throughout the specification) is not in the list, the MME/S4-SGSN transmits an indication of reselecting an SGW-U node to the current SGW-C node, which may be carried by e.g., a Modify Bearer Request message. Then, the SGW-C node performs SGW-U reselection according to the indication received from the MME/S4-SGSN.
The MME allocates a TAI List to the UE, both the SGW-C service area and the SGW-U service area need to be considered, i.e., the TAs included in the TAI list should all be served by both the currently selected SGW-C node and SGW-U node, e.g., when the UE needs to be closer to the SGW-U node.

To support these ideas of the present disclosure, the following functionalities should also be supported by related network elements.
In mobility procedures without SGW-C change but with SGW-U change, the SGW-C establishes an Sx Session with the new SGW-U and trigger a Modify Bearer Request message towards the PGW.
If the SGW-U changes after SGW-U selection, the SGW-C informs the MME/S4-SGSN of the new selected SGW-U node name (e.g., FQDN) and/or SGW-U node IP in e.g. a Create Session Response message or a Modify Bearer Response message. The related procedures may be e.g., PDN connectivity (such as E-UTRAN initial Attach with PDN Connectivity, UE requested PDN Connectivity), mobility with SGW-C change (such as Tracking Area Update (TAU) with SGW-C change, X2-based handover with SGW-C change, S1-based handover with SGW-C change, Routing Area Update (RAU) with SGW-C change, Serving Radio Network Sub-system (SRNS) Relocation with SGW-C change, or the like), or mobility without SGW-C change (such as TAU without SGW-C change, X2-based handover without SGW-C change, S1-based handover without SGW-C change, RAU without SGW-C change, SRNS Relocation without SGW-C change, or the like). The MME/S4-SGSN stores the latest SGW-U node name (e.g., FQDN) and/or SGW-U node IP from the SGW-C for the UE if available.
During inter-node mobility (e.g., inter-MME TAU or inter-MME handover), the source MME/S4-SGSN transmits the current SGW-U node name (e.g., FQDN) and/or SGW-U node IP to the target MME/S4-SGSN in e.g., a Forward Relocation Request message (for handover) and/or a Context Response message (for TAU/Routing Area Update (RAU)) if available. The target MME/S4-SGSN could store the SGW-U node name (e.g., FQDN) and/or SGW-U node IP from the source MME/S4-SGSN for later use.
Additionally, an APN which prefers closer topology between the UE and the SGW-U (e.g. an MEC APN) may be configured in the MME/S4-SGSN, and the technical solution of the present disclosure may be applied on such an APN.

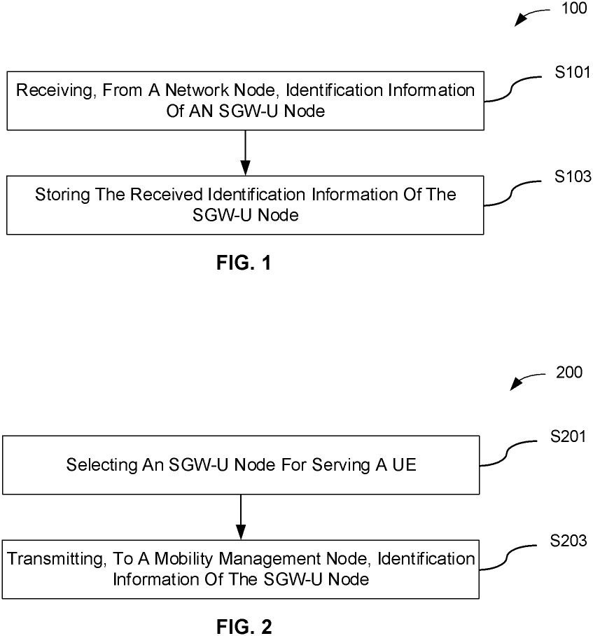

Hereinafter, a method 100 at a mobility management node for SGW-U selection according to an exemplary embodiment of the present disclosure will be described with reference to FIG. 1. The mobility management node may include at least one of: an MME, an S4-SGSN, or any node that has the mobility management function, including a virtualized node that may be implemented on cloud.

As shown in FIG. 1, the method 100 includes steps S101~S103.

In step S101, the mobility management node may receive, from a network node, identification information of an SGW-U node. The SGW-U node was selected by the current SGW-C node.

In an exemplary embodiment, the identification information of the SGW-U node may include at least one of:
node name (such as FQDN) information of the SGW-U node, or
node IP information of the SGW-U node.

The network node may be the current SGW-C node, or another mobility management node.

An exemplary embodiment in which the network node is the current SGW-C node relates to such procedures as e.g., PDN connectivity (such as E-UTRAN initial Attach with PDN Connectivity, UE requested PDN Connectivity), mobility with SGW-C change (such as TAU with SGW-C change, X2-based handover with SGW-C change, S1-based handover with SGW-C change, RAU with SGW-C change, SRNS Relocation with SGW-C change, or the like), or mobility without SGW-C change (such as TAU without SGW-C change, X2-based handover without SGW-C change, S1-based handover without SGW-C change, RAU without SGW-C change, SRNS Relocation without SGW-C change, or the like). In these procedures, the mobility management node receives, from the current SGW-C node, identification information of the SGW-U node selected by the current SGW-C node.

The identification information of the SGW-U node from the current SGW-U node may be carried by a Create Session Response message, or a Modify Bearer Response message.

It should be understood that although some exemplary procedures are described above, the present disclosure is not limited to those, but may also be applied in any procedure in which a Create Session Response message or a Modify Bearer Response message is used for carrying the identification information of the SGW-U node to the mobility management node.

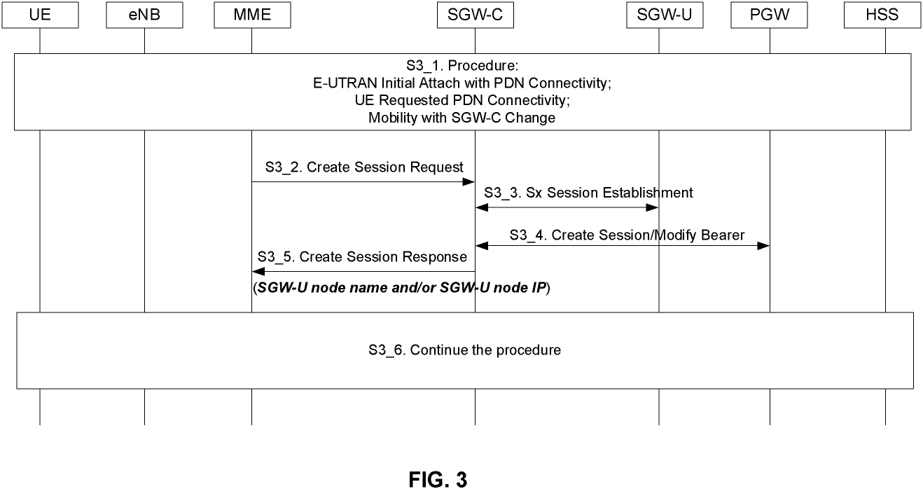

In such procedures as e.g., PDN connectivity (such as E-UTRAN initial Attach with PDN Connectivity, UE requested PDN Connectivity), mobility with SGW-C change (such as TAU with SGW-C change, X2-based handover with SGW-C change, S1-based handover with SGW-C change, RAU with SGW-C change, SRNS Relocation with SGW-C change, or the like), the mobility management node receives, from the current SGW-C node, identification information of the SGW-U node selected by the current SGW-C node in the Create Session Response message, which will be described in detail later with reference to FIG. 3.

It should be understood that although FIG. 3 shows only one mobility management node (in this example, MME), FIG. 3 is applicable to illustrate such procedures as inter-MME TAU with SGW-C change, inter-MME S1-based handover with SGW-C change, inter-SGSN RAU with SGW-C change, inter-SGSN SRNS Relocation with SGW-C change, etc. In this case, the mobility management node may represent a target/new mobility management node, which receives the identification information of the SGW-U node in the Create Session Response message from the current SGW-C node that was selected by the (i.e., target/new) mobility management node.

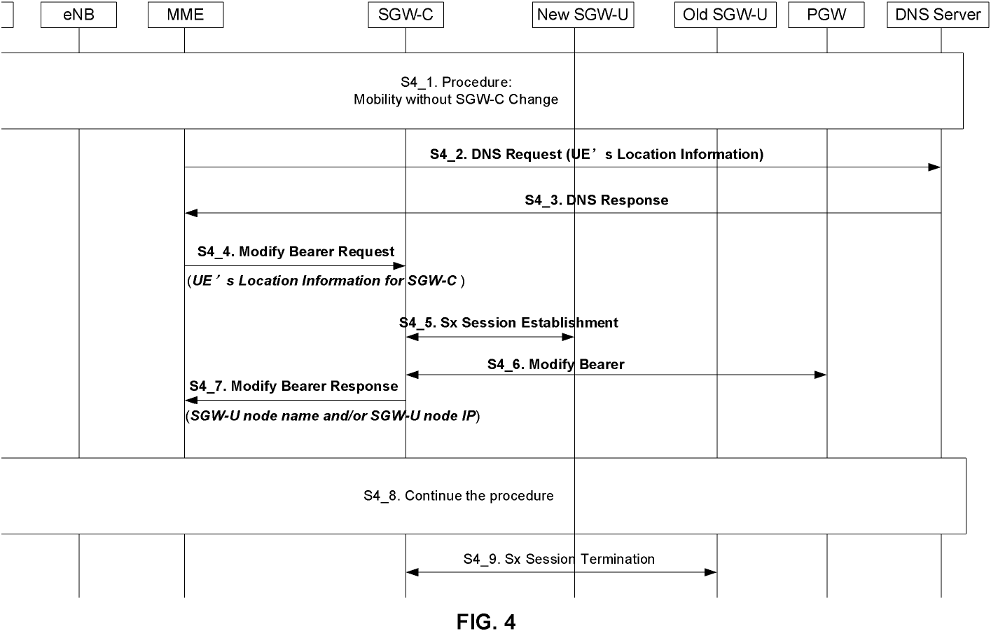

In such procedures as e.g., mobility without SGW-C change (such as TAU without SGW-C change, X2-based handover without SGW-C change, S1-based handover without SGW-C change, RAU without SGW-C change, SRNS Relocation without SGW-C change, or the like), the mobility management node receives, from the current SGW-C node, identification information of the SGW-U node selected by the current SGW-C node in the Modify Bearer Response message, which will be described in detail later with reference to FIG. 4.

It should be understood that although FIG. 4 shows only one mobility management node (in this example, MME), FIG. 4 is applicable to such procedures as inter-MME TAU without SGW-C change, inter-MME S1-based handover without SGW-C change, inter-SGSN RAU without SGW-C change, inter-SGSN SRNS Relocation without SGW-C change, etc. In this case, the mobility management node may represent a target/new mobility management node, which receives the identification information of the SGW-U node in the Modify Bearer Response message from the current SGW-C node that was selected by the (i.e., target/new) mobility management node.

An exemplary embodiment in which the network node is another mobility management node relates to such procedures as e.g., inter-MME TAU or inter-MME handover, the mobility management node (as the target/new mobility management node) receives, from another mobility management node (here, an old/source mobility management node), identification information of the SGW-U node selected by the current SGW-C node.

The identification information of the SGW-U node from the other mobility management node may be carried by a Context Response message, or a Forward Relocation Request message.

It should be understood that although some exemplary procedures are described above, the present disclosure is not limited to those, but may also be applied in any procedure in which a Context Response message or a Forward Relocation Request message is used for carrying the identification information of the SGW-U node to the mobility management node.

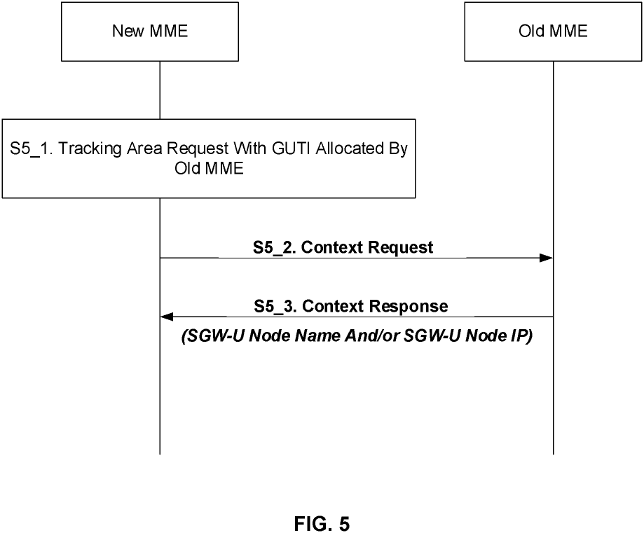

In such procedures as e.g., inter-MME TAU, the mobility management node receives, from the other mobility management node (e.g., an old mobility management node), identification information of the SGW-U node selected by the current SGW-C node in the Context Response message, which will be described in detail later with reference to FIG. 5.

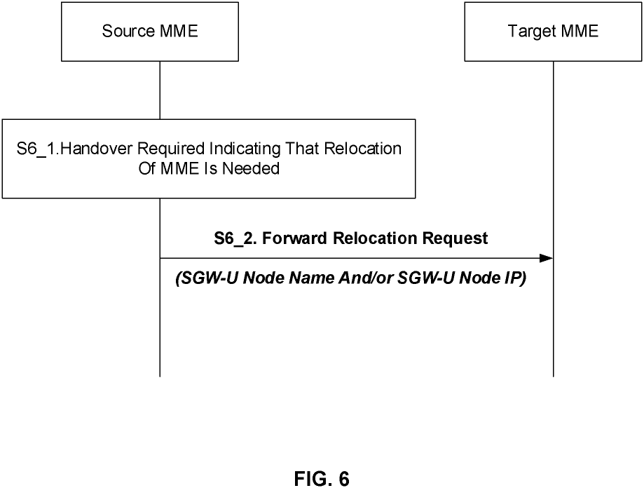

In such procedures as e.g., inter-MME handover, the mobility management node receives, from the other mobility management node (e.g., a source mobility management node), identification information of the SGW-U node selected by the current SGW-C node in the Forward Relocation Request message, which will be described in detail later with reference to FIG. 6.

After the mobility management node receives the identification information of the SGW-U node, the mobility management node may store, in step S103, the received identification information of the SGW-U node for later use e.g., in SGW-U (re)selection.

In an exemplary embodiment, e.g., in the mobility procedure without SGW-C change, such as TAU without SGW-C change, X2-based handover without SGW-C change, S1-based handover without SGW-C change, RAU without SGW-C change, SRNS Relocation without SGW-C change, as exemplarily shown in FIG. 4, the method 100 may further include the following steps of indicating SGW-U reselection to SGW-C (not shown in FIG. 1).

The mobility management node may obtain a list of identification information of SGW-U nodes and a list of identification information of SGW-C nodes, at least partially based on location information of the UE, and optionally on UE Usage Type, the APN, UE capabilities etc. by using a DNS procedure, such as an S-NAPTR procedure.

The mobility management node may select an SGW-C node according to e.g., TAI. In this embodiment, the mobility management node finds that the current SGW-C node can serve the TA, i.e., without SGW-C change.

Then, the mobility management node may determine whether the current SGW-U node needs change by checking if the stored identification information of the current SGW-U node is in the obtained list.

The mobility management node may determine that the current SGW-U node needs change, if the stored identification information of the current SGW-U node is not in the obtained list.

Then, the mobility management node may transmit, to the SGW-C node, an indication of reselecting an SGW-U node by the SGW-C node.

The indication of reselecting an SGW-U node may be carried by a Modify Bearer Request message.

The indication of reselecting an SGW-U node may include at least the location information of the UE, such as ECGI, eNB or TAI for E-UTRAN, or RAI or RNC-ID for UTRAN.

Optionally, the indication may also include an indication flag indicating that the SGW-U node needs change.

After the SGW-C node reselects an SGW-U node according to the indication of the mobility management node, the SGW-C node triggers an Sx Session Establishment procedure to the reselected SGW-U node (new SGW-U node), and initiates a Modify Bearer procedure to the PGW node to inform the SGW-U change.

Then, the mobility management node receives a Modify Bearer Response message from the SGW-C node (i.e., step S101 is repeated). In the Modify Bearer Response message, identification information of the reselected SGW-U node is included, so that the mobility management node stores the identification information of the reselected SGW-U node for later use in SGW-U reselection (i.e., step S103 is repeated), if necessary.

In TAU Accept to the UE, the mobility management node may allocate TAI list containing one or more TAs which can all be served by both the current SGW-C node and SGW-U node.

It should be understood that in such procedures as inter-MME TAU without SGW-C change, inter-MME S1-based handover without SGW-C change, etc., after in step S101, the mobility management node, as a target/new mobility management node, receives, from the current SGW-C node that was selected by the (i.e., target/new) mobility management node, a Modify Bearer Response message including identification information of the current SGW-U node, and stores, in step S103, the identification information of the current SGW-U node for later use in SGW-U reselection, the mobility management node also performs the previously described steps of indicating SGW-U reselection to SGW-C.

Similarly, in the procedures, e.g., inter-MME TAU as exemplarily shown in FIG. 5, and e.g., inter-MME handover as exemplarily shown in FIG. 6, after in step S101, the mobility management node, as a target/new mobility management node, receives, from another (i.e., the source/old) mobility management node, a Context Response message (for inter-MME TAU) or a Forward Relocation Request message (for inter-MME handover) including identification information of the current SGW-U node, and stores, in step S103, the identification information of the current SGW-U node for later use in SGW-U reselection, the target/new mobility management node also performs the previously described steps of indicating SGW-U reselection to SGW-C.

Hereinafter, a method 200 at an SGW-C node for SGW-U selection according to an exemplary embodiment of the present disclosure will be described with reference to FIG. 2. The SGW-C node may include any node that has the serving gateway control plane function, including a virtualized node that may be implemented on cloud. As previously described, the mobility management node may include at least one of: an MME, an S4-SGSN, or any node that has the mobility management function, including a virtualized node that may be implemented on cloud.

It should be understood that the method 200 at the SGW-C node for SGW-U selection is corresponding to the method 100 at the mobility management node for SGW-U selection. Thus, some detailed description of method 200 may also refer to that of method 100.

As shown in FIG. 2, the method 200 includes steps S201~S203.

In step S201, the SGW-C node may select an SGW-U node for serving a UE, with any approach in the conventional technical solutions.

Then, the SGW-C node may trigger an Sx Session Establishment procedure to the selected SGW-U node.

The SGW-C node may initiate a Modify Bearer procedure to the PGW node, with any approach in the conventional technical solutions.

Then in step S203, the SGW-C node may transmit, to a mobility management node, identification information of the selected SGW-U node.

In an exemplary embodiment, the identification information of the SGW-U node may include at least one of:
node name (such as FQDN) information of the selected SGW-U node, or
node IP information of the selected SGW-U node.

As previously described in step S101 of method 100, the identification information of the SGW-U node from the current SGW-U node may be carried by a Create Session Response message, or a Modify Bearer Response message.

In such procedures as e.g., PDN connectivity (such as E-UTRAN initial Attach with PDN Connectivity, UE requested PDN Connectivity), mobility with SGW-C change (such as TAU with SGW-C change, X2-based handover with SGW-C change, S1-based handover with SGW-C change, RAU with SGW-C change, SRNS Relocation with SGW-C change, or the like) as exemplarily shown in FIG. 3, the SGW-C node transmits, to the mobility management node, identification information of the selected SGW-U node in the Create Session Response message.

It should be understood that although FIG. 3 shows only one mobility management node (in this example, MME), FIG. 3 is applicable to illustrate such procedures as inter-MME TAU with SGW-C change, inter-MME S1-based handover with SGW-C change, inter-SRNS RAU with SGW-C change, inter-SRNS Relocation with SGW-C change, etc. In this case, the SGW-C node that was selected by the (i.e., target/new) mobility management node transmits, to the (i.e., target/new) mobility management node, identification information of the selected SGW-U node in the Create Session Response message.

In such procedures as e.g., mobility without SGW-C change (such as TAU without SGW-C change, X2-based handover without SGW-C change, S1-based handover without SGW-C change, RAU without SGW-C change, SRNS Relocation without SGW-C change, or the like) as exemplarily shown in FIG. 4, the SGW-C node transmits, to the mobility management node, identification information of the selected SGW-U node in the Modify Bearer Response message.

It should be understood that although FIG. 4 shows only one mobility management node (in this example, MME), FIG. 4 is applicable to illustrate such procedures as inter-MME TAU without SGW-C change, inter-MME S1-based handover without SGW-C change, inter-SGSN RAU without SGW-C change, inter-SRNS Relocation without SGW-C change, etc. In this case, the SGW-C node that was selected by the (i.e., target/new) mobility management node (not shown) transmits, to the (i.e., target/new) mobility management node, identification information of the selected SGW-U node in the Modify Bearer Response message.

As previously described in step S103 of method 100, After the mobility management node receives the identification information of the SGW-U node, the mobility management node may store the received identification information of the SGW-U node for later use e.g., in SGW-U (re)selection.

In an exemplary embodiment, e.g., in the mobility procedure without SGW-C change, such as TAU without SGW-C change, X2-based handover without SGW-C change, S1-based handover without SGW-C change, RAU without SGW-C change, SRNS Relocation without SGW-C change, as exemplarily shown in FIG. 4, the method 200 may further include the following steps of indicating SGW-U reselection to SGW-C (not shown in FIG. 2).

As previously described, in the steps of the mobility management node indicating SGW-U reselection to SGW-C in method 100, the mobility management node obtains a list of identification information of SGW-U nodes and a list of identification information of SGW-C nodes, at least partially based on location information of the UE, and optionally on UE Usage Type, the APN, UE capabilities etc. by using a DNS procedure, such as an S-NAPTR procedure; selects an SGW-C node according to e.g., TAI (in this embodiment, the mobility management node finds that the current SGW-C node can serve the TA, i.e., without SGW-C change); determines that the current SGW-U node needs change, in a case that the stored identification information of the current SGW-U node is not in the obtained list; and transmits, to the SGW-C node, an indication of reselecting an SGW-U node by the SGW-C node.

Accordingly, the SGW-C node receives, from the mobility management node, the indication of reselecting an SGW-U node. Then, the SGW-C node reselects an appropriate SGW-U node (i.e., step S201 is repeated). And, the SGW-C node transmits, to the mobility management node, identification information of the reselected SGW-U node for the mobility management node later use in SGW-U reselection (i.e., step S203 is repeated), if necessary.

As previously described, the indication of reselecting an SGW-U node includes at least location information of the UE, and optionally, an indication flag indicating that the SGW-U node needs change.

FIG. 3 schematically shows an exemplary signaling sequence diagram of a PDN Connectivity procedure or a Mobility procedure with SGW-C Change in which methods 100 and 200 for SGW-U selection according to exemplary embodiments of the present disclosure are applied. It should be noted that the description below only focuses on signaling related to the methods 100 and 200, and other signaling is omitted to avoid obscuring the principle of the present disclosure. In FIG. 3, modification on the signaling related to the methods 100 and 200 is shown in Bold Italics.

In the exemplary procedure as shown in FIG. 3, the mobility management node is an MME. As previously described, the mobility management node may also be an S4-SGSN, or any node that has the mobility management function, including a virtualized node that may be implemented on cloud. The SGW-C node as shown in FIG. 3 may include any node that has the serving gateway control plane function, including a virtualized node that may be implemented on cloud.

As shown in FIG. 3, Signaling S3_1 relates to procedures that may be performed, e.g., E-UTRAN initial Attach with PDN Connectivity, UE Requested PDN Connectivity, or Mobility with SGW-C change. Here, the Mobility procedure with SGW-C change may include: TAU with SGW-C change, X2-based handover with SGW-C change, S1-based handover with SGW-C change, RAU with SGW-C change, SRNS Relocation with SGW-C change, etc.

Although not described here, it should be understood that the methods for SGW-U selection according to exemplary embodiments of the present disclosure may also be applied in similar procedures for PDP Activation using S4 in S4-SGSN.

In Signaling S3_2, as legacy, the MME selects a SGW-C node and a PGW node at least partially based on location information of the UE, and optionally on UE Usage Type, the APN, UE capabilities etc., and transmits a Create Session Request message to the selected SGW-C node.

In Signaling S3_3, as legacy, the SGW-C node selects an SGW-U node for CUPS as previously described in step S201 of the method 200 at the SGW-C node, and triggers an Sx Session Establishment procedure towards the selected SGW-U.

In Signaling S3_4, as legacy, the SGW-C node initiates a Create Session or a Modify Bearer procedure towards the PGW.

In Signaling S3_5, the SGW-C node transmits a Create Session Response message to the MME, as previously described in step S101 of the method 100 at the MME and step S203 of the method 200 at the SGW-C node. In particularly, the SGW-C node includes the SGW-U node name (e.g., FQDN) and/or SGW-U node IP in the Create Session Response message. Then, the MME stores the received SGW-U node name and/or SGW-U node IP for later use in SGW-U reselection, if necessary, as previously described in step S103 of the method 100 at the MME.

In Signaling S3_6, the procedure continues.

As previously described, it should be understood that although FIG. 3 shows only one MME, FIG. 3 is applicable to illustrate such procedures as inter-MME TAU with SGW-C change, inter-MME S1-based handover with SGW-C change, inter-SGSN RAU with SGW-C change, inter-SGSN SRNS Relocation with SGW-C change, etc. In this case, the MME may represent a target/new MME, which receives the identification information of the SGW-U node in the Create Session Response message from the current SGW-C node that was selected by the (i.e., target/new) MME.

FIG. 4 schematically shows an exemplary signaling sequence diagram of a Mobility procedure without SGW-C change but with SGW-U change in which methods 100 and 200 for SGW-U selection according to exemplary embodiments of the present disclosure are applied. It should be noted that the description below only focuses on signaling related to the methods 100 and 200, and other signaling is omitted to avoid obscuring the principle of the present disclosure. In FIG. 4, modification on the signaling related to the methods 100 and 200 is shown in Bold Italics.

In the exemplary procedure as shown in FIG. 4, the mobility management node is an MME. As previously described, the mobility management node may also be an S4-SGSN, or any node that has the mobility management function, including a virtualized node that may be implemented on cloud. The SGW-C node as shown in FIG. 4 may include any node that has the serving gateway control plane function, including a virtualized node that may be implemented on cloud.

As shown in FIG. 4, Signaling S4_1 relates to procedures that may be performed, e.g., mobility without SGW-C change, such as TAU without SGW-C change, X2-based handover without SGW-C change, S1-based handover without SGW-C change, RAU without SGW-C change, SRNS Relocation without SGW-C change, or the like.

Although not described here, it should be understood that the methods for SGW-U selection according to exemplary embodiments of the present disclosure may also be applied in similar procedures for mobility without SGW-C change with SGW-U change in S4-SGSN. For S4-SGSN, the location information of the UE for DNS procedure may be RAI/RNC ID.

The procedure is mobility without SGW-C change, and may include e.g. TAU without SGW-C change, X2-based handover without SGW-C change, S1-based handover without SGW-C change, RAU without SGW-C change, SRNS Relocation without SGW-C change, etc.

In Signaling S4_2 and S4_3, the MME uses a DNS (e.g., S-NAPTR) procedure to obtain a list of identification information of SGW-U nodes and a list of identification information of SGW-C nodes, at least partially based on location information of the UE, and optionally on UE Usage Type, the APN, UE capabilities etc.. The MME selects an SGW-C node at least partially based on location information of the UE (e.g., TAI, optionally eNB-ID, etc.), and optionally on UE Usage Type, the APN, UE capabilities etc. as legacy. In this case, the MME finds that the current SGW-C node can serve the TA, i.e., without SGW-C change.

The MME determines whether the current SGW-U node can serve the UE according to the location information of the UE (e.g., TAI, optionally eNB-ID, etc.) by checking if the stored identification information (e.g., SGW-U node name or SGW-U node IP or SGW-U session IP (in SGW-U FTEID)) of the current SGW-U node is in the obtained list of identification information of SGW-U nodes.

If the stored identification information of the current SGW-U node is in the obtained list, the MME may determine that the current SGW-U node can still serve the UE, and thus the current SGW-U node does not need to change. The MME will handle the TAU as legacy.

If the stored identification information of the current SGW-U node is not in the obtained list, the MME determines that the current SGW-U node needs change, and the process proceeds to Signaling S4_4.

In Signaling S4_4, since SGW-U needs change, the MME transmits to the SGW-C node, an indication of reselecting an SGW-U node by the SGW-C node in a Modify Bearer Request message.

The indication of reselecting an SGW-U node may include at least the location information of the UE, such as ECGI, eNB or TAI for E-UTRAN, or RAI or RNC-ID for UTRAN. Optionally, the indication may include an indication flag indicating that the SGW-U node needs change. For example, ‘Change F-TEID support Indication’ should be set to 1. Additionally or alternatively, some indication flag is set to indicate that the SGW-U node needs change.

In Signaling S4_5, the SGW-C node reselects an SGW-U node, and triggers an Sx Session Establishment procedure towards the new SGW-U node.

In Signaling S4_6, the SGW-C node initiates a Modify Bearer procedure towards the PGW node to inform SGW-U change.

In Signaling S4_7, the SGW-C node transmits a Modify Bearer Response message to the MME as previously described in step S101 of the method 100 at the MME and step S203 of the method 200 at the SGW-C node. In particularly, the SGW-C node includes the SGW-U node name (e.g., FQDN) and/or SGW-U node IP in the Create Session Response message. Then, the MME stores the received SGW-U node name and/or SGW-U node IP for later use in SGW-U reselection, if necessary, as previously described in step S103 of the method 100 at the MME.

In Signaling S4_8, the procedure continues. In TAU accept to the UE, the MME allocates the TAI list containing one or more TAs which can all be served by both the current SGW-C node and SGW-U node.

In Signaling S4_9, the SGW-C node triggers an Sx Session Termination procedure towards the old SGW-U during the procedure.

As previously described, it should be understood that although FIG. 4 shows only one MME, FIG. 4 is applicable to such procedures as inter-MME TAU without SGW-C change, inter-MME S1-based handover without SGW-C change, inter-SGSN RAU without SGW-C change, inter--SGSN SRNS Relocation without SGW-C change, etc. In this case, the MME may represent a target/new MME, which receives the identification information of the SGW-U node in the Modify Bearer Response message from the current SGW-C node that was selected by the (target/new) MME (not shown).

FIG. 5 schematically shows an exemplary signaling sequence diagram in an inter-MME TAU procedure in which methods 100 and 200 for SGW-U selection according to exemplary embodiments of the present disclosure are applied. It should be noted that the description below only focuses on signaling related to the methods 100 and 200, and other signaling is omitted to avoid obscuring the principle of the present disclosure. In FIG. 5, modification on the signaling related to the methods 100 and 200 is shown in Bold Italics.

In the exemplary procedure as shown in FIG. 5, the mobility management node is an MME. As previously described, the mobility management node may also be an S4-SGSN, or any node that has the mobility management function, including a virtualized node that may be implemented on cloud.

As shown in FIG. 5, Signaling S5_1 relates to procedures that may be performed, e.g., inter-MME TAU, or the like.

In Signaling S5_2, the new MME transmits a Context Request message to the old MME to retrieve user information.

In Signaling S5_3, the old MME transmits a Context Response message to the new MME. In particularly, the old MME includes the SGW-U node name (e.g., FQDN) and/or SGW-U node IP in the Context Response message. Then, the new MME stores the received SGW-U node name and/or SGW-U node IP for later use in SGW-U reselection, if necessary, as previously described in step S103 of the method 100 at the MME. It should be understood that the subsequent steps are identical with those described with reference to FIGS. 1~4, and thus description thereof will be omitted for simplicity.

FIG. 6 schematically shows an exemplary signaling sequence diagram in an inter-MME Handover procedure in which methods 100 and 200 for SGW-U selection according to exemplary embodiments of the present disclosure are applied. It should be noted that the description below only focuses on signaling related to the methods 100 and 200, and other signaling is omitted to avoid obscuring the principle of the present disclosure. In FIG. 6, modification on the signaling related to the methods 100 and 200 is shown in Bold Italics.

In the exemplary procedure as shown in FIG. 6, the mobility management node is an MME. As previously described, the mobility management node may also be an S4-SGSN, or any node that has the mobility management function, including a virtualized node that may be implemented on cloud.

As shown in FIG. 6, Signaling S6_1 relates to procedures that may be performed, e.g., inter-MME Handover, or the like.

In Signaling S6_2, the source MME transmits a Forward Relocation Request message to the target MME. The source MME includes the SGW-U node name (e.g., FQDN) and/or SGW-U node IP in the Forward Relocation Request message. Then, the target MME stores the received SGW-U node name and/or SGW-U node IP for later use in SGW-U reselection, if necessary, as previously described in step S103 of the method 100 at the MME. It should be understood that the subsequent steps are identical with those described with reference to FIGS. 1~4, and thus description thereof will be omitted for simplicity.

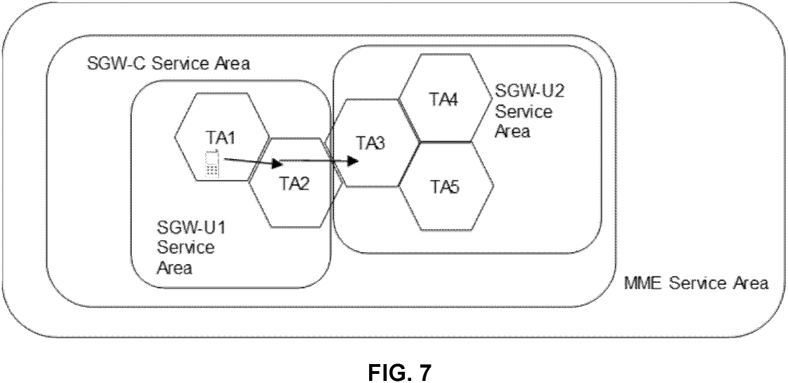

FIG. 7 schematically shows an exemplary scenario in which SGW-U selection according to an exemplary embodiment of the present disclosure is applied during intra-MME Mobility without SGW-C change.

In the exemplary scenario as shown in FIG. 7, the Service Area of SGW-C covers TA1, TA2, TA3, TA4 and TA5, the Service Area of SGW-U1 covers TA1 and TA2, and the Service Area of SGW-U2 covers TA3, TA4 and TA5.

Firstly, the UE is attached in TA1. The UE is served by the SGW-C and the SGW-U1. The MME stores e.g., FQDN and/or IP of the SGW-U1 from SGW-C. If the MME allocates a TAI List based on visited TAls, TA1 is included in the TAI List.

Then, the UE moves to TA2. As previously described in steps of indicating SGW-U reselection to SGW-C of method 100, the MME selects an SGW-C and finds that the SGW-C doesn’t change. According to e.g., the UE’s APN, the UE needs to be closer with SGW-U, so the MME shall use the DNS (e.g., S-NAPTR) procedure to obtain a list of SGW-U which can serve TA2. The MME finds that e.g. FQDN and/or IP of the SGW-U1 are in the list, then just follow legacy. If the MME allocates a TAI List based on visited TAls, TA1 and TA2 are included in the TAI List just as legacy. That means, if the UE moves back to TA1, TAU is not needed.

Then, the UE moves to TA3. As previously described in steps of indicating SGW-U reselection to SGW-C of method 100, the MME selects an SGW-C and finds that the SGW-C doesn’t change. Then, the MME shall use the DNS (e.g., S-NAPTR) procedure to obtain a list of SGW-U which can serve TA3. The MME finds that e.g. FQDN and/or IP of the SGW-U1 are not in the list, the MME should send a Modify Bearer Request message with UE Location Information for SGW, alternatively or additionally with an indication flag to notify the SGW-C that the SGW-U needs to be re-selected. Thus, the SGW-U2 is selected by SGW-C, as previously described in step S201 of method 200. The SGW-C sends a Modify Bearer Response message with e.g. FQDN and/or IP of the SGW-U2 to the MME, as previously described in step S203 of method 200. The MME receives e.g. FQDN and/or IP of the SGW-U2, as previously described in step S101 of method 100, and stores e.g. FQDN and/or IP of the SGW-U2 for later use in SGW-U reselection as previously described in step S103 of method 100. If the MME allocates a TAI List based on visited TAls, only TA3 that can all be served by both the currently selected SGW-C node and SGW-U node is included in TAI List.

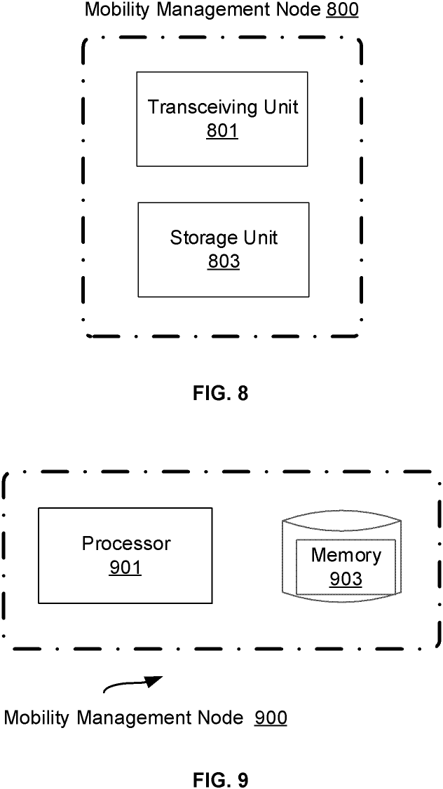

Hereinafter, a structure of a mobility management node according to an exemplary embodiment of the present disclosure will be described with reference to FIG. 8. FIG. 8 schematically shows a block diagram of a mobility management node 800 according to an exemplary embodiment of the present disclosure. The mobility management node 800 in FIG. 8 may perform the method 100 as described previously with reference to FIG. 1. Accordingly, some detailed description on the mobility management node 800 may refer to the corresponding description of the method 100 in FIG. 1 and the signaling sequence diagrams of FIGS. 3~6 as previously discussed, and thus will be omitted here for simplicity.

As shown in FIG. 8, the mobility management node 800 includes a transceiving unit 801 and a storage unit 803.

The transceiving unit 801 may receive, from a network node, identification information of an SGW-U node.

In an exemplary embodiment, the identification information of the SGW-U node comprises at least one of:
node name information of the SGW-U node, or
node IP information of the SGW-U node.

The storage unit 803 may store the received identification information of the SGW-U node.

In an exemplary embodiment, the network node is another mobility management node, the SGW-U node was selected by an SGW-C node, and the identification information of the SGW-U node from the other mobility management node is carried by one of:
a Context Response message, or
a Forward Relocation Request message.

In an exemplary embodiment, any of the mobility management node and the other mobility management node includes at least one of: MME, or S4-SGSN, or any node that has the mobility management function, including a virtualized node that may be implemented on cloud.

In an exemplary embodiment, the mobility management node 800 may further include a selection unit (not shown), which may select an SGW-C node at least partially based on location information of a UE.

In an exemplary embodiment, the mobility management node 800 may further include an obtaining unit and a determination unit (not shown).

The obtaining unit obtains a list of identification information of SGW-U nodes at least partially based on location information of the UE;

The determination unit determines that the SGW-U node needs change if the stored identification information of the SGW-U node is not in the obtained list.

Then, the transceiving unit 801 transmits an indication of reselecting an SGW-U node to the selected SGW-C node.

In an exemplary embodiment, the indication of reselecting an SGW-U node is carried by a Modify Bearer Request message, and includes at least the location information of the UE. The identification information of the SGW-U node from the selected SGW-C node is carried by the Modify Bearer Response message.

In an exemplary embodiment, the mobility management node 800 may further include an allocation unit (not shown), that may allocate, to the UE, a TAI list containing one or more TAs which can all be served by both the currently selected SGW-C node and SGW-U node.

Hereinafter, a structure of a mobility management node according to another exemplary embodiment of the present disclosure will be described with reference to FIG. 9. FIG. 9 schematically shows a block diagram of a mobility management node 900 according to another exemplary embodiment of the present disclosure. The mobility management node 900 in FIG. 9 may perform the method 100 as described previously with reference to FIG. 1. Accordingly, some detailed description on the mobility management node 900 may refer to the corresponding description of the method 100 in FIG. 1 and the signaling sequence diagrams of FIGS. 3~6 as previously discussed, and thus will be omitted here for simplicity.

As shown in FIG. 9, the mobility management node 900 includes at least one processor 901 and at least one memory 903. The at least one processor 901 includes e.g., any suitable CPU (Central Processing Unit), microcontroller, DSP (Digital Signal Processor), etc., capable of executing computer program instructions. The at least one memory 903 may be any combination of a RAM (Random Access Memory) and a ROM (Read Only Memory). The at least one processor memory 903 may also include persistent storage, which, for example, can be any single one or combination of magnetic memory, optical memory, or solid state memory or even remotely mounted memory.

The at least one memory 903 stores instructions executable by the at least one processor 901. The instructions, when loaded from the at least one memory 903 and executed on the at least one processor 901, may cause the mobility management node 900 to perform the actions, e.g., of the procedures as described earlier respectively in conjunction with FIG. 1 with reference to the signaling sequence diagrams of FIGS. 3~6 as previously discussed, and thus will be omitted here for simplicity.

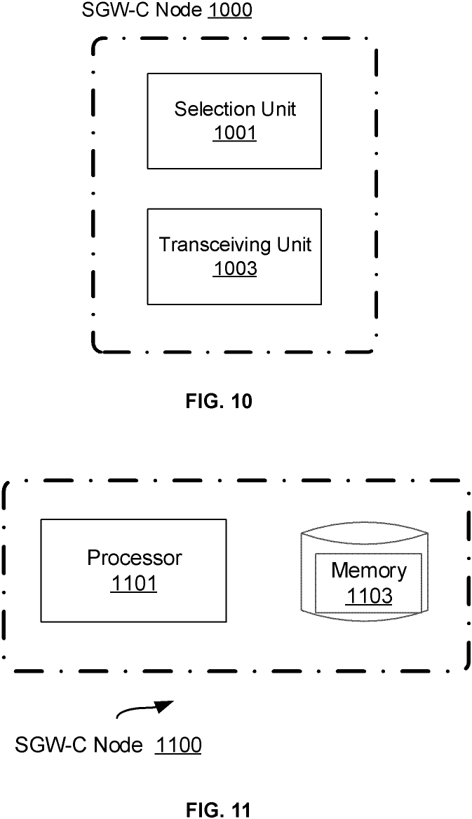

Hereinafter, a structure of an SGW-C node according to an exemplary embodiment of the present disclosure will be described with reference to FIG. 10. FIG. 10 schematically shows a block diagram of an SGW-C node 1000 according to an exemplary embodiment of the present disclosure. The SGW-C node 1000 in FIG. 10 may perform the method 200 as described previously with reference to FIG. 2. Accordingly, some detailed description on the SGW-C node 1000 may refer to the corresponding description of the method 200 in FIG. 2 and the signaling sequence diagram of FIGS. 3~4 as previously discussed, and thus will be omitted here for simplicity.

The SGW-C node may include any node that has the serving gateway control plane function, including a virtualized node that may be implemented on cloud.

As shown in FIG. 10, the SGW-C node 1000 includes a selection unit 1001 and a transceiving unit 1003.

The selection unit 1001 may select an SGW-U node for serving a UE.

The transceiving unit 1003 may transmit, to a mobility management node, identification information of the SGW-U node.

In an exemplary embodiment, the identification information of the SGW-U node comprises at least one of:
node name information of the SGW-U node, or
node IP information of the SGW-U node.

In an exemplary embodiment, the mobility management node may include at least one of: an MME, an S4-SGSN, or any node that has the mobility management function, including a virtualized node that may be implemented on cloud.

In an exemplary embodiment, the identification information of the SGW-U node is carried by one of:
a Create Session Response message, or
a Modify Bearer Response message.

In an exemplary embodiment, the SGW-C node was selected by the mobility management node at least partially based on location information of the UE.

In an exemplary embodiment, the transceiving unit 1003 may receive, from the mobility management node, an indication of reselecting an SGW-U node. Then, the selection unit 1001 may reselect an appropriate SGW-U node.

Hereinafter, a structure of an SGW-C node according to another exemplary embodiment of the present disclosure will be described with reference to FIG. 11. FIG. 11 schematically shows a block diagram of an SGW-C node 1100 according to an exemplary embodiment of the present disclosure. The SGW-C node 1100 in FIG. 11 may perform the method 200 as described previously with reference to FIG. 2. Accordingly, some detailed description on the SGW-C node 1100 may refer to the corresponding description of the method 200 in FIG. 2 and the signaling sequence diagram of FIGS. 3~4 as previously discussed, and thus will be omitted here for simplicity.

As shown in FIG. 11, the SGW-C node 1100 includes at least one processor 1101 and at least one memory 1103. The at least one processor 1101 includes e.g., any suitable CPU (Central Processing Unit), microcontroller, DSP (Digital Signal Processor), etc., capable of executing computer program instructions. The at least one memory 1103 may be any combination of a RAM (Random Access Memory) and a ROM (Read Only Memory). The at least one processor memory 1103 may also include persistent storage, which, for example, can be any single one or combination of magnetic memory, optical memory, or solid state memory or even remotely mounted memory.

The at least one memory 1103 stores instructions executable by the at least one processor 1101. The instructions, when loaded from the at least one memory 1103 and executed on the at least one processor 1101, may cause the SGW-C node 1100 to perform the actions, e.g., of the procedures as described earlier respectively in conjunction with FIG. 2 with reference to the signaling sequence diagrams of FIGS. 3~4 as previously discussed, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 901 causes the mobility management node 900 to perform the actions, e.g., of the procedure described earlier in conjunction with FIG. 1; or code/computer readable instructions, which when executed by the at least one processor 1101 causes the SGW-C 1100 to perform the actions, e.g., of the procedures described earlier respectively in conjunction with FIG. 2.

The computer program product may be configured as a computer program code structured in computer program modules. The computer program modules could essentially perform the actions of the flow illustrated in any of FIGS. 1 to 6.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The present disclosure has been described above with reference to embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached.

1. A method at a mobility management node, comprising:
receiving, from a network node, identification information of a Serving Gateway-User plane (SGW-U) node; and
storing the received identification information of the SGW-U node.

2. The method of claim 1, wherein the identification information of the SGW-U node comprises at least one of:
node name information of the SGW-U node, or
node IP information of the SGW-U node.

3. The method of claim 1, wherein the network node is a Serving Gateway-Control plane (SGW-C) node, the SGW-U node is selected by the SGW-C node, and the identification information of the SGW-U node from the SGW-U node is carried by one of:
a Create Session Response message, or
a Modify Bearer Response message.

4. The method of claim 1, wherein the network node is another mobility management node, the SGW-U node is selected by an SGW-C node, and the identification information of the SGW-U node from the other mobility management node is carried by one of:
a Context Response message, or
a Forward Relocation Request message.

5. The method of claim 4, wherein one of the mobility management node or the other mobility management node comprises at least one of:
a Mobility Management Entity (MME), or
an S4-Serving GPRS Support Node (S4-SGSN).

6. The method of claim 3, further comprising:
selecting the SGW-C node at least partially based on location information of a User Equipment (UE).

7. The method of claim 6,further comprising:
obtaining a list of identification information of SGW-U nodes at least partially based on location information of the UE;
determining that the SGW-U node needs change if the stored identification information of the SGW-U node is not in the obtained list; and
transmitting an indication of reselecting an SGW-U node to the selected SGW-C node.

8. The method of claim 7, wherein
the indication of reselecting the SGW-U node is carried by a Modify Bearer Request message, and comprises at least the location information of the UE; and
the identification information of the SGW-U node from the selected SGW-C node is carried by the Modify Bearer Response message.

9. The method of claim 8, further comprising:
allocating, to the UE, a Tracking Area Identity (TAI) list containing one or more TAs which can all be served by both the currently selected SGW-C node and SGW-U node.

10. A method at a Serving Gateway-Control plane (SGW-C) node, comprising:
selecting a Serving Gateway-User plane (SGW-U) node for serving a User Equipment (UE); and
transmitting, to a mobility management node, identification information of the SGW-U node.

11. The method of claim 10, wherein the identification information of the SGW-U node comprises at least one of:
node name information of the SGW-U node, or
node IP information of the SGW-U node.

12. The method of claim 10, wherein the identification information of the SGW-U node is carried by one of:
a Create Session Response message, or
a Modify Bearer Response message.

13. The method of claim 10, wherein the SGW-C node is selected by the mobility management node at least partially based on location information of the UE.

14. The method of claim 13, further comprising:
receiving, from the mobility management node, an indication of reselecting an SGW-U node; and
reselecting an SGW-U node.

15. The method of claim 14, wherein
the indication of reselecting the SGW-U node is carried by a Modify Bearer Request message, and comprises at least the location information of the UE; and
the identification information of the SGW-U node is carried by the Modify Bearer Response message.

16. The method of claim 10,wherein the mobility management node comprises at least one of:
a Mobility Management Entity (MME), or
an S4-Serving GPRS Support Node (S4-SGSN).

17. A mobility management node, comprising:
at least one processor; and
at least one memory, storing instructions which, when executed on the at least one processor, cause the mobility management node to:
receive, from a network node, identification information of a Serving Gateway-User plane (SGW-U) node; and
store the received identification information of the SGW-U node.

18. (canceled)

19. A Serving Gateway-Control plane (SGW-C) node, comprising:
at least one processor; and
at least one memory, storing instructions which, when executed on the at least one processor, cause the SGW-C node to:
select a Serving Gateway-User plane (SGW-U) node for serving a User Equipment (UE); and
transmit, to a mobility management node, identification information of the SGW-U node.

20-22. (canceled)
